(19) United States
(12) Patent Application Publication
(10) Pub. No.: US 2016/0004952 A1
(43) Pub. Date: Jan. 7, 2016

(54) WEARABLE TAG CAPABLE OF WIRELESS COMMUNICATIONS

(71) Applicant: VivaLnk, Inc., Santa Clara, CA (US)

(72) Inventor: Junfeng Mei, Sunnyvale, CA (US)

(21) Appl. No.: 14/321,807

(22) Filed: Jul. 2, 2014

(51) Int. Cl. G06K 19/077

(52) U.S. Cl. CPC G06K 19/07762; G06K 19/07722; G06K 19/0776

(57) ABSTRACT

A wearable tag capable of wireless communications includes a dry inlay layer having a lower surface, an upper surface, and a side surface, wherein the dry inlay layer is embedded with a semiconductor chip and an antenna circuit that are configured to wirelessly communicate with external devices. The wearable tag also includes an adhesive layer on the lower surface of the dry inlay layer. The adhesive layer is adapted to adhere to a human skin. An elastic layer on at least a portion of the upper surface of the dry inlay layer provides flexibility to the wearable tag.

### BACKGROUND OF THE INVENTION

The present application relates to wearable wireless electronic devices, and in particular, to tag-like wireless devices that can adhere to human skin.

Near Field Communication (NFC) is a wireless communication standard which enables two devices in a short range to establish a communication channel within a short period of time through radio waves in the 13.56 MHz frequency range. NFC can be a useful technology for data transfer between two devices in close proximity to one another. Because it needs the two devices to be in close proximity to one another (less than 10 cm), it is more secure than other wireless technologies like Bluetooth and Wi-Fi. Hence, it can be seen as an easy and secure tool for establishing quick two-way connections for data transfer. NFC is a two-way communication tool, one of the devices/cards can have a passive NFC tag that can reduce the cost and still behave in the same way as any other RFID tag.

This communication standard is being increasingly adopted for use in wireless transactions, including money transfer, loyalty coupons, gift cards, transit passes, tickets, etc. Mobile handset manufacturing companies are increasingly integrating NFC hardware in their phones. For example, the 2014 CES badges employed NFC technology and have resulted in shorter lines, more badge functionality, and greater ease of use for attendees and exhibitors. NFC has also been increasingly used in the fields of medical devices, electronic health records, as well as wearable tagging devices.

Wearable tag is an electronic tag that can be worn by a user. Wearable tag is required to stay on user's skin and function for 5-7 days. A wearable tag can contain a silicon chip and antenna that can be accessed using NFC technologies. An authentication wearable tag can be used as a “password” similar to a barcode. For example, it can be used to recognize a user's smart phone for authentication purpose.

Despite initial development efforts, wearable tags still face several challenges: they may not provide adequate comfort for users to wear them; they may not stay attached to user's body for the required length of time; their components can be fragile and be easily broken; they are usually not aesthetically appealing.

### SUMMARY OF THE INVENTION

The presently disclosure attempts to address the aforementioned limitations in conventional wearable tags. The disclosed wearable tags are of high flexibility, breathability, and low profile, which make them more comfortable for users to wear than conventional electronic wearable tag. The disclosed wearable tags offer increased robustness for electronic sensing, frequency response range, and durability in the electronic components. The disclosed wearable tags include improved structures that allow them to stay in contact with skin for longer period of time. Furthermore, the disclosed wearable tags are also aesthetically appealing.

In one general aspect, the present invention relates to a wearable tag capable of wireless communications that includes a dry inlay layer comprising a lower surface, an upper surface, and a side surface, wherein the dry inlay layer is embedded with a semiconductor chip and an antenna circuit that are configured to wirelessly communicate with external devices; an adhesive layer on the lower surface of the dry inlay layer, wherein the adhesive layer is adapted to adhere to a human skin; and an elastic layer on at least a portion of the upper surface of the dry inlay layer, providing flexibility to the wearable tag.

Implementations of the system may include one or more of the following. The elastic layer can have a Young's Modulus lower than 0.3 Gpa. The elastic layer can include an elastomer material. The elastic layer can include polyurethane or silicone. The elastic layer can also be on the side surface of the dry inlay layer, wherein the elastic layer extends beyond lateral dimensions of the dry inlay layer and is in contact with the adhesive layer. The elastic layer can extends laterally beyond an edge of the dry inlay layer. The elastic layer can cover substantially the whole upper surface of the dry inlay layer. The elastic layer can extend laterally beyond an edge of the adhesive layer. The elastic layer can have substantially the same width as the adhesive layer. The dry inlay layer has a Young's Modulus higher than 1.0 Gpa. The dry inlay layer can include Polyimide or Polyethylene terephthalate. The adhesive layer can be pressure sensitive. The dry inlay layer can include through holes to allow the human skin to breathe through the wearable tag. The through holes can also run through the elastic layer on the supper surface of the dry inlay layer. The dry inlay layer can include a graphic pattern, wherein the antenna circuit and the graphic pattern are made of a same conductive material. The antenna circuit and the graphic pattern can be formed from a same metal layer. The graphic pattern can be substantially encircled by the antenna circuit. The semiconductor chip and the antenna circuit in the dry inlay layer can communicate with external devices based on near field communication (NFC), Wi-Fi, Bluetooth, or RFID wireless communication standard. The wearable tag can further include multiple curved connection leads that connect ends of the antenna circuit and metal pads that seat the semiconductor chip.

These and other aspects, their implementations and other features are described in detail in the drawings, the description and the claims.

### BRIEF DESCRIPTION OF THE DRAWINGS

FIG. 1 is a photo of a wearable tag on a person's wrist.

FIG. 2 is an exploded perspective view of a wearable tag in accordance with some embodiments of the present invention.

FIG. 3 is a cross-sectional of a wearable tag in accordance with some embodiments of the present invention.

FIG. 4 is a cross-sectional of another wearable tag in accordance with some embodiments of the present invention.

FIG. 5 is a top view of a wearable tag in accordance with some embodiments of the present invention.

FIG. 6 is a top view of another wearable tag in accordance with some embodiments of the present invention.

FIG. 7 shows an exemplified layout for the connections between from the metal pads that seat a semiconductor chip to an end of the antenna in the disclosed wearable tag in accordance with some embodiments of the present invention.

### DETAILED DESCRIPTION OF THE INVENTION

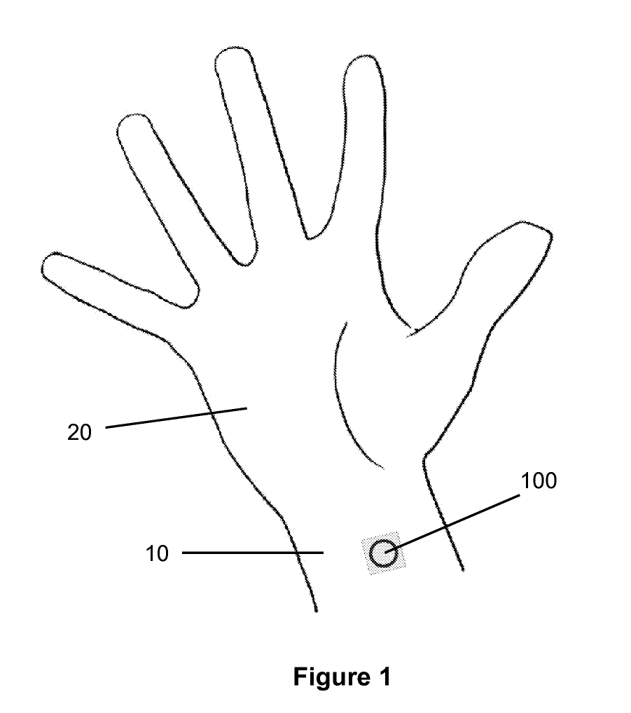

Referring to FIG. 1, a wearable tag 100 can be placed on and adhere to a person's wrist 10, as or other parts of the person's body such as hand 20, arm, shoulder, waist, leg, etc.

As discussed above, there are several challenges for wearable tags on human skin. The tags need to stay on skin for 5-7 days enduring various daily activities such as taking showers or bathes, swimming, exercises, holding weights, etc. The tags are rubbed by clothing numerous times a day. While it is very challenging to keep Band-Aid stickers to stay on skin for a week, the wearable tags normally have much stiffer rigid substrates, which make them more easily rubbed off than Band-Aid stickers.

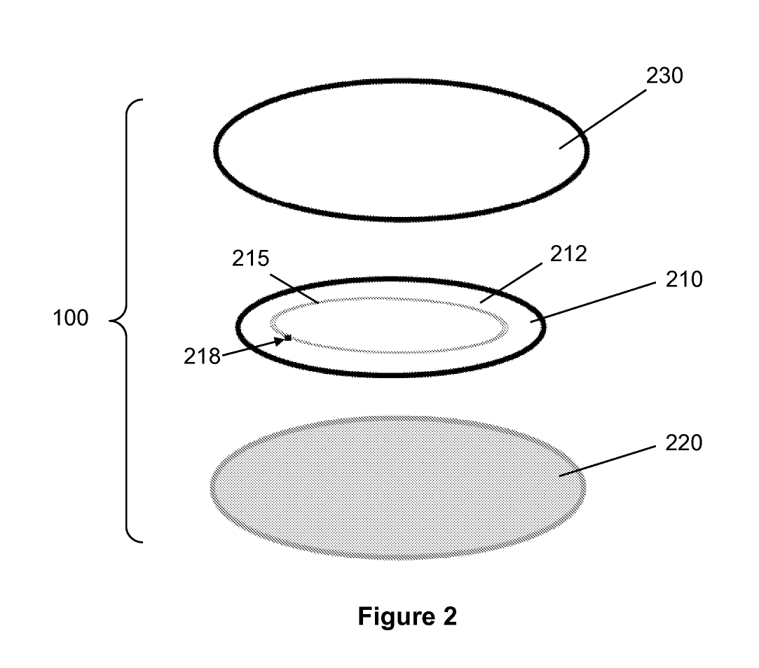

The presently disclosed apparatus aims to overcome the drawbacks in the conventional wearable tags. Referring to FIG. 2, the wearable tag 100 includes a dry inlay layer 210 in the middle, an adhesive layer 220 under the dry inlay layer 210, and an elastic layer 230 on at least a portion of the dry inlay layer 210.

The dry inlay layer 210 includes a thin film substrate 212, and a semiconductor chip 218 and an antenna 215 embedded in the thin film substrate 212. The antenna 215 (i.e. the antenna circuit) can be formed by a coil of metal lines that are wound in one or more circles. Suitable metal for the antenna includes copper, aluminum, gold, silver, stainless steel, etc. The semiconductor chip 218 and the antenna 215 are configured to communicate with external devices based on NFC standard, RFID, Wi-Fi, Bluetooth, or other types of wireless communication standard. Examples of external devices include smart phones, computers, mobile payment devices, scanners and readers, medical devices, security systems, personal identification systems, etc. To provide physical support to the antenna 215 and the semiconductor chip 218, the thin film substrate 212 includes relatively rigid polymer materials such as Polyimide (PI) or Polyethylene terephthalate (PET). In some embodiments, the thin film substrate 212 in the dry inlay layer 210 has a Young's Modulus >1 Gpa.

The adhesive layer 220 can be pressure sensitive, that is, it allows the wearable tag 100 tightly adhere to human skin under pressure, applied for example by a thumb. For instance, the adhesive layer 220 can be made of a medical pressure sensitive adhesive. An example of such adhesive is medical grade tackified Hypoallergenic Pressure Sensitive Adhesive.

The elastic layer 230 is used to improve the flexibility and durability of the wearable tag 100. The elastic layer 230 is flexible, and can conform to the skin under different moving positions. The elastic layer 230 is also breathable allow aspiration and moisture from the skin to be released to the environment. The elastic layer 230 can be made of a viscoelastic polymeric material having low Young's modulus and high failure strain. In some embodiments, the elastic layer 230 has a Young's Modulus <0.3 Gpa. In some cases, the elastic layer 230 has a Young's Modulus <0.1 Gpa to provide enhanced flexibility and tackability. Materials suitable for the elastic layer include elastomers, viscoelastic polymers, such as silicone, and medical grade polyurethane that is a transparent medical dressing used to cover and protect wounds with breathability and conformation to skin.

It has been observed that the elastic layer can reduce the impact of rubbing force on the rigid dry inlay layer underneath, which provides better protection to the semiconductor chip and the antenna and reduces the probability of falling off, thus increasing the life span of the wearable tag.

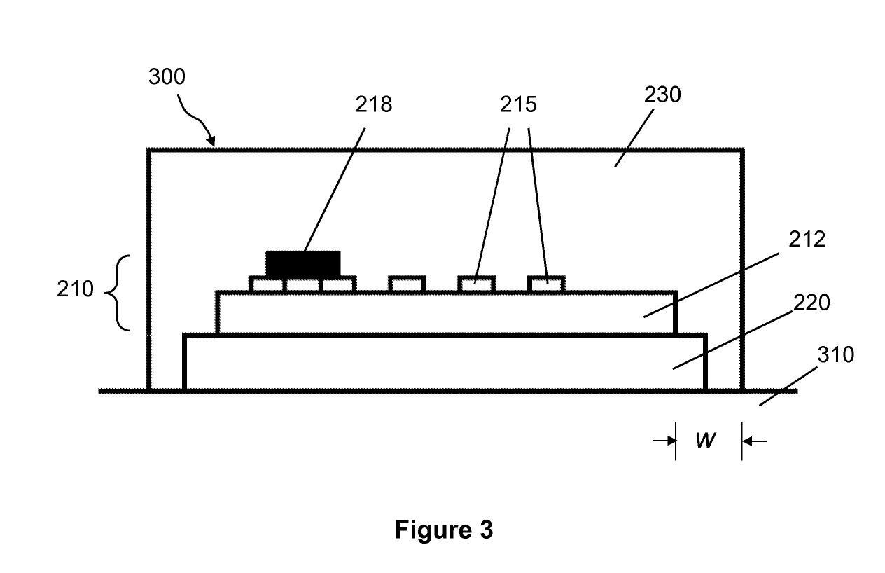

In some embodiments, referring to FIG. 3, a wearable tag 300 on skin 310 includes the dry inlay layer 210, the adhesive layer 220, and the elastic layer 230 as described above. To ensure good contact and adherence to the skin 310, the elastic layer 230 extends horizontally beyond the width of the dry inlay layer 210 such that the elastic layer 230 is positioned on and covers side surface(s) of the dry inlay layer 210. The elastic layer 230 comes to direct contact with the adhesive layer 220 in the bottom. In some embodiments, the elastic layer 230 extends laterally beyond edges of the dry inlay layer 210 by a width ‘w’, wherein the width ‘w’ can be more than 200 μm.

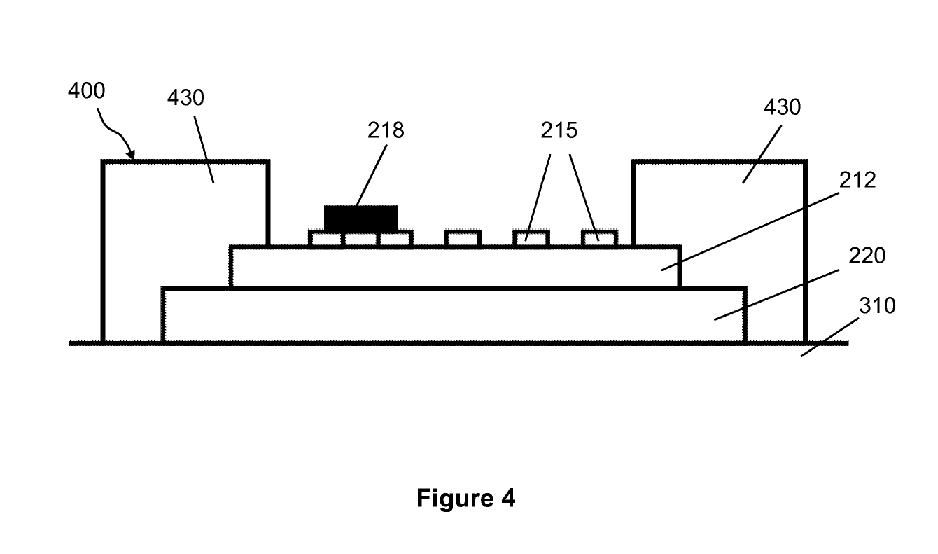

In some embodiments, the elastic layer 230 can have substantially the same width as the adhesive layer 220. In some embodiments, the elastic layer 230 extends laterally beyond edges of the adhesive layer 220, as shown in FIG. 3 (and FIG. 4 as described below).

The elastic layer 230 can be made of an elastomer material such as silicone or polyurethane. By enclosing the relatively rigid dry inlay layer 210 by elastic or viscoelastic materials, the semiconductor chip 218 and the antenna 215 are protected, which results in significantly longer lifetime for the wearable tag 300.

To provide additional protection, the semiconductor chip 218 and the antenna 215 are placed on the upper (or outer) side of the dry inlay layer 210. The thin film substrate 212 protects the semiconductor chip 218 and the antenna 215 from direct rubbing against the skin 310 during wearer's body movement, which increases the lifetime of the wearable tag 100. The thin film substrate 212 can also shield sweat released from the skin 310 from the semiconductor chip 218 and the antenna 215.

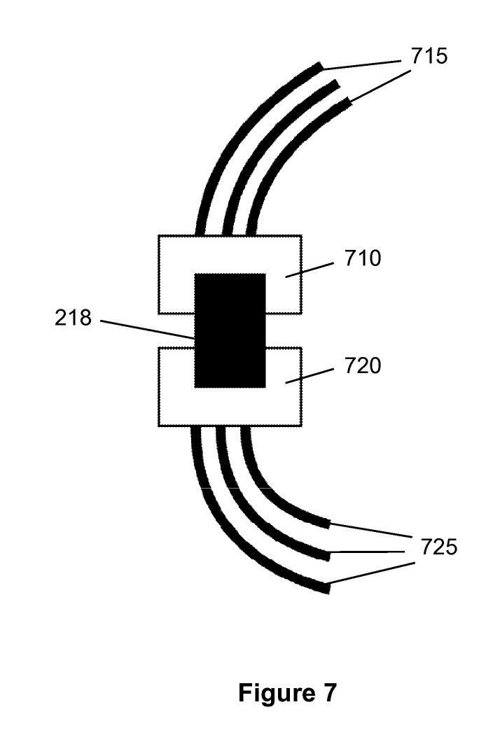

The wearable tag 300 can be manufactured by the exemplified process below. To prepare for form the thin film substrate 212, a plastic film is electroplated or vacuum deposited with a metal layer on its upper surface and a metal layer on its bottom surface. Vias are then formed to connect the metal layers on the upper and the lower surface of the plastic film. The metal layers are then patterned by lithography, and selectively etched off areas of metals to form the antenna circuit and metal pads. The antenna circuit can include a conductive line in a spiral curve extended in several circles. The semiconductor chip 218 is attached to the metal pads on the plastic film to form a functional dry inlay layer 210. The metal pads and connected to the ends of the antenna circuit by connection leads (shown in FIG. 7). The elastic layer 230 and the adhesive layer 220 are laminated to the two sides of dry inlay layer 210. The assembly of the multi-layer structure is then cut by die or laser to the right dimensions.

In some embodiments, referring to FIG. 4, a wearable tag 400 on skin 310 includes the dry inlay layer 210 and the adhesive layer 220, as described above. An elastic layer 430 is disposed on the edge portion on the upper surface of the dry inlay layer 210 as well as the side surface of the dry inlay layer 210. The elastic layer 430 comes to contact with the adhesive layer 220. The elastic layer 430 can be selectively disposed on the dry inlay layer 210 and the adhesive layer 220 by for example a fluid delivery device such as an ink jet print head, screen printing process, or flexographic process, other layer formation methods known in the art of the field.

One key drawback of the conventional wearable tags is that the rigid polymer substrate does not allow much breathability to the skin. The build-up of seat and moisture can cause discomfort and irritation to the skin, especially after wearing it for an extended period of 5-7 days. Conventional wearable tags also have the look of industrial and medical devices, which are not aesthetically appealing for daily wearing.

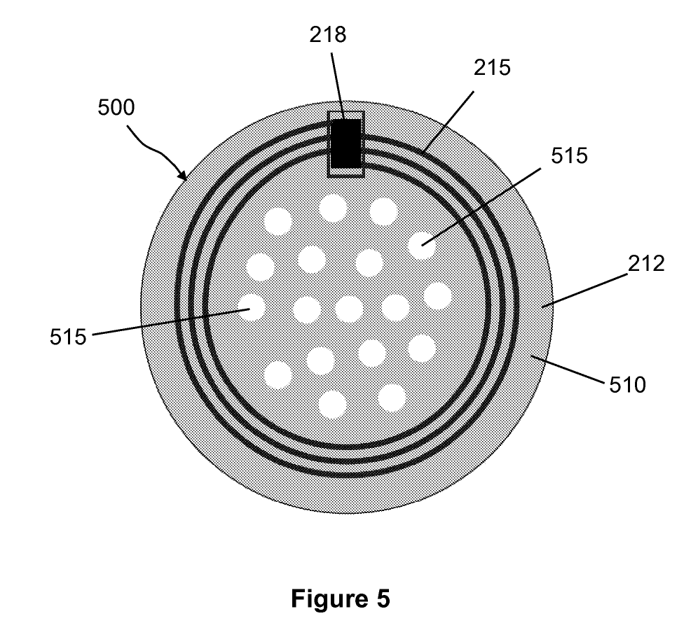

Another aspect of the disclosed wearable tags is to provide breathability to wearer's skin. Referring to FIG. 5, a wearable tag 500 includes a dry inlay layer 510 which includes a thin film substrate 212, and a semiconductor chip 218 and an antenna 215 embedded in the thin film substrate 212. In addition, the dry inlay layer 510 includes a plurality of perforation or through holes 515 which are intended to provide permeability of moisture or sweat released from the skin to outside (i.e. breathability). In some embodiments, the holes 515 can be formed through the dry inlay layer 510, as well as the elastic layer 230 and/or the adhesive layer 220 (FIGS. 2 and 3). The holes 515 are formed in areas of the thin film substrate 212 other than the antenna 215 and the semiconductor chip 218. For example, the holes 515 can be formed in central areas encircled by the antenna 215, as shown in FIG. 5.

The holes 515 can be formed in the dry inlay layer 510 using laser ablation, drilling, stamping, or other techniques before or after the antenna 215 and the semiconductor chip 218 are embedded in the thin film substrate 212. In some embodiments, the holes 515 can be formed in a same process as the via holes that are made to connect the metal layers on the upper and lower surfaces of the plastic film that is used to form the dry inlay layer 510, as described in the manufacturing process above.

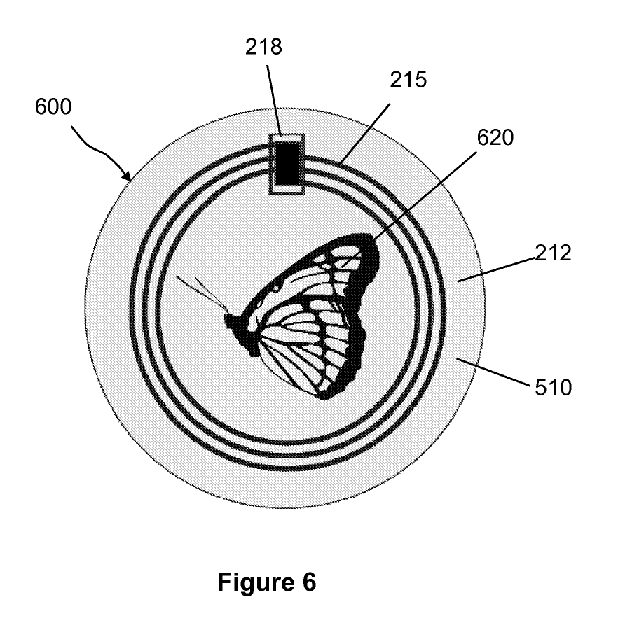

Yet another aspect of the disclosed wearable tags is to provide aesthetic appeal to the users. Referring to FIG. 6, a wearable tag 600 includes a graphic pattern 620. In some embodiments, the graphic pattern 620 is formed in the central area encircled by the antenna 215. In some embodiments, the graphic pattern 620 is formed in a same metal layer as the antenna 215, thus allowing both formed in a single manufacturing process. For example, the metal layer (e.g. a copper layer) can be patterned with a mask, and etched to form the antenna coils as well as the graphic pattern 620.

In some embodiments, the graphic pattern 620 provides more than aesthetics to the wearable tag 500. The antenna 215 receives or transmits wireless electromagnetic signals by a LC (inductor-capacitor) circuit. When the graphic pattern 620 is made using a connective material (such as the same metal layer from which the antenna 215 is formed), the graphic pattern 620 can modify the inductance-capacitance response by producing a counter inductive eddy current in the graphic pattern 620, which can increase the stability of wireless reception and transmission, and broaden the frequency response window of the wearable tag 500.

In some embodiments, the graphic pattern 620 (shown in FIG. 6) and the holes 515 (shown in FIG. 5) can be formed in a same wearable tag to provide combined breathability, aesthetic appeal, as well as wireless operation robustness.

In conventional wearable tags, the semiconductor chip, the antenna circuit, and especially the connection leads from the metal pads to the ends of antenna circuit are often broken due to repeated stretching and compression as a result of skin movement; they can also be damaged through the chemical erosion of sweat. It is found the connection leads between the semiconductor chip and the antenna circuits are often the weakest link where the breakages occur.

The presently disclosed wearable tags seek to overcome this shortcoming. Referring to FIG. 7, the semiconductor chip 218 is seated between metal pads 710 and 720 with epoxy. Instead of a single copper line with a right angle turn in conventional wearable tags, multiple connection leads 715 and 725 are respectively connected to the metal pads 710 and 720. The other ends of the connection leads 715 and 725 are connected to the ends of the antenna. The multiple connection leads 715 and 725 have curved shapes instead of sharp 90 degree turns, which makes them easily adapted to skin movement with minimum stress and reduced change for breakage. The redundancy also ensures wearable tag's continued operation even some of the connection leads 715 and 725 are broken.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination.

Only a few examples and implementations are described. Other implementations, variations, modifications and enhancements to the described examples and implementations may be made without deviating from the spirit of the present invention. For example, the usages of the disclosed wearable tags are not limited by the examples given above; they can be applicable to many other fields. The materials suitable for the different layers of the wearable tags are also not limited by the examples provided. The layouts and forms of the elastic layer, the breathing holes, the decorative pattern, the semiconductor chip, the antenna, the metal pads, and the connection leads can have other configurations without deviating from the present invention.

What is claimed is:

1. A wearable tag capable of wireless communications, comprising:
a dry inlay layer comprising a lower surface, an upper surface, and a side surface, wherein the dry inlay layer is embedded with a semiconductor chip and an antenna circuit that are configured to wirelessly communicate with external devices;
an adhesive layer on the lower surface of the dry inlay layer, wherein the adhesive layer is adapted to adhere to a human skin; and
an elastic layer on at least a portion of the upper surface of the dry inlay layer, providing flexibility to the wearable tag.

2. The wearable tag of claim 1, wherein the elastic layer has a Young's Modulus lower than 0.3 Gpa.

3. The wearable tag of claim 1, wherein the elastic layer comprises an elastomer material.

4. The wearable tag of claim 1, wherein the elastic layer comprises polyurethane or silicone.

5. The wearable tag of claim 1, wherein the elastic layer is also on the side surface of the dry inlay layer, wherein the elastic layer extends beyond lateral dimensions of the dry inlay layer and is in contact with the adhesive layer.

6. The wearable tag of claim 5, wherein the elastic layer extends laterally beyond an edge of the dry inlay layer.

7. The wearable tag of claim 1, wherein the elastic layer covers substantially the whole upper surface of the dry inlay layer.

8. The wearable tag of claim 1, wherein the elastic layer extends laterally beyond an edge of the adhesive layer.

9. The wearable tag of claim 1, wherein the elastic layer has substantially a same width as the adhesive layer.

10. The wearable tag of claim 1, wherein the dry inlay layer has a Young's Modulus higher than 1.0 Gpa.

11. The wearable tag of claim 1, wherein the dry inlay layer comprises Polyimide or Polyethylene terephthalate.

12. The wearable tag of claim 1, wherein the adhesive layer is pressure sensitive.

13. The wearable tag of claim 1, wherein the dry inlay layer includes through holes to allow the human skin to breathe through the wearable tag.

14. The wearable tag of claim 13, wherein the through holes also run through the elastic layer on the supper surface of the dry inlay layer.

15. The wearable tag of claim 1, wherein the dry inlay layer includes a graphic pattern, wherein the antenna circuit and the graphic pattern are made of a same conductive material.

16. The wearable tag of claim 15, wherein the antenna circuit and the graphic pattern are formed from a same metal layer.

17. The wearable tag of claim 15, wherein the graphic pattern is substantially encircled by the antenna circuit.

18. The wearable tag of claim 1, wherein the semiconductor chip and the antenna circuit in the dry inlay layer are configured to communicate with external devices based on near field communication (NFC), Wi-Fi, Bluetooth, or RFID wireless communication standard.

19. The wearable tag of claim 1, further comprising:
multiple curved connection leads that connect ends of the antenna circuit and metal pads that seat the semiconductor chip.
